(19) United States
(12) Patent Application Publication
(10) Pub. No.: US 2017/0350317 A1
(43) Pub. Date: Dec. 7, 2017

(54) ARRANGEMENT COMPRISING A TURBOMACHINE, AND ASSOCIATED OPERATING METHOD

(71) Applicant: DIEHL AEROSPACE GMBH, Ueberlingen (DE)

(72) Inventors: Steffen POGGEL, Stuttgart (DE); Sven SCHMIDT, Stuttgart (DE)

(73) Assignee: DIEHL AEROSPACE GMBH, Ueberlingen (DE)

(21) Appl. No.: 15/612,264

(22) Filed: Jun. 2, 2017

(30) Foreign Application Priority Data
Jun. 2, 2016 (DE) 102016006764.0

(51) Int. Cl. F02C 6/08; F02C 6/20; F02C 7/22

(52) U.S. Cl. CPC F02C 6/08; F02C 7/22; F02C 6/203; F05D 2220/32

(57) ABSTRACT

The invention relates to an arrangement (1, 15), comprising a turbomachine (2, 16) with a compressor (3) having an outlet (7), and with a bleed air line (9), through which a leakage flow can flow and which is connected via a controllable valve (8) to the outlet (7) of the compressor (3), for supplying the leakage flow to a unit, characterized in that the unit is designed as a fan (17), jet pump (10) or pump which can be driven by the leakage flow. The invention also relates to a method for operating the arrangement (1, 15).

### BACKGROUND OF THE INVENTION

The present invention relates to an arrangement, comprising a turbomachine with a compressor having an outlet, and with a bleed air line, through which a leakage flow can flow and which is connected via a controllable valve to the outlet of the compressor, for supplying the leakage flow to a unit.

### DISCUSSION OF THE PRIOR ART

The term “turbomachine” used in this application encompasses all turbomachines, for example a steam turbine, a gas turbine, a turbocompressor or a jet engine.

Turbomachines of this type are characterized by very high mass flow. In order to be able to operate a turbomachine in an energy-efficient manner over a large pressure range and in different operating states, an overflow device is usually present in order to regulate the mass flow. An overflow device of this kind is needed in order to avoid disadvantageous effects that can arise due to flow conditions of the turbomachine. Turbomachines are able to deliver a very high mass flow, wherein in general average pressure ratios are present.

A turbomachine is usually provided with a static or controllable bleed air line, which is also termed bypass or “bleed valve”. The bleed air line takes a leakage flow from a compressor stage of the turbomachine, thus ensuring that the compressor does not work against a closed volume. However, the leakage flow represents a loss of drive energy since the leakage flow has previously passed through one or more compressor stages. The leakage flow, also termed “bleed air”, is for example used for climate control in the cabin in the case of airborne vehicles. This is intended to use at least part of the energy contained in the leakage flow, which would otherwise be lost, unused.

U.S. Pat. No. 5,137,230 A discloses a gas turbine for an aircraft with a bleed air line connected to its compressor. By controlling a valve, a leakage flow can be taken from a compressor stage and supplied to a pre-cooler. The air is then supplied to a climate control unit which conditions the leakage flow by means of a turbine-compressor unit and by means of a heat exchanger. The air flow leaving the climate control unit at the outlet is used for temperature control in the passenger cabin of the aircraft.

Similarly, US 2015/0176501 A1 proposes supplying a leakage flow via a bleed air line to a turbine-compressor unit. Thence, part of the leakage flow goes to a climate control unit (or environmental control system, ECS), or to a de-icing unit.

### SUMMARY OF THE INVENTION

The present invention is directed to specifying an arrangement with a turbomachine which offers greater options for using a leakage flow taken via a bleed air line.

Accordingly, the present invention provides, in the context of an arrangement of the type mentioned in the introduction, that the unit is designed as a fan, jet pump or pump which can be driven by the leakage flow.

It has been found, in the context of the invention, that the leakage flow taken via the bleed air line can be used not only for cooling or ventilating an aircraft cabin. According to the invention, the bleed air line is for example connected to a unit designed as a pump. The pump is driven by the leakage flow, more specifically by the kinetic energy of the latter, i.e. under the action of the flow velocity of the flowing fluid, in particular of the air flowing through the turbomachine. In addition, it is also possible to use the potential energy contained in the leakage flow in order to drive the unit, in particular a pump, under the action of the overpressure generated in the compressor. The pump driven by the leakage flow can serve a specific function of the arrangement according to the invention, such that it is possible to dispense with a separate pump or another unit. It is also conceivable that a unit, for example a conventional pump, can be made smaller since at least part of the driving energy is taken from the leakage flow.

In one preferred embodiment of the invention, the outlet of the compressor is connected to the controllable valve via a plenum. The plenum is a volume and serves to distribute the mass flow generated by the compressor. The plenum has at least one first outlet. Sub-assemblies, which are or can be supplied with a mass flow generated by the compressor, are or can be connected to the at least one first outlet of the plenum. The controllable valve is connected to a second outlet of the plenum, and is thus connected to the latter. The controllable valve has the object of opening and closing in order to set a certain pressure in the plenum. In an open state of the controllable valve, a leakage flow is taken or bled from the plenum via the controllable valve. For example, if the pressure in the plenum exceeds a certain setpoint value, the controllable valve is opened such that the pressure in the plenum drops to the setpoint value. The leakage flow bled in this manner thus flows via the controllable valve into the bleed air line, and can be supplied thereby to the unit. Thus, the invention uses the energy of the leakage flow flowing through the controllable valve in order to drive the unit.

In the context of the arrangement according to the invention, it can be provided that the unit is designed as a jet pump. This is a pump for delivering a gaseous or liquid medium and can be driven solely by the leakage flow, that is to say by the bleed air taken from a compressor stage. This has the advantage that the jet pump can be used to deliver a medium other than the leakage flow, for example ambient air or cabin air, so that no—or just a smaller—unit is required for this. Alternatively, the unit of the arrangement according to the invention can also be designed as a fan. The fan makes it possible to deliver a gas, for example cooling air or air used for temperature control.

In the context of the arrangement according to the invention, it is preferred that neither a pre-cooler nor a compressor is arranged between the controllable valve and the unit. Accordingly, the unit of the arrangement according to the invention is directly connected, via the bleed air line, to the compressor or to a compressor stage. In particular, there are no components which have a notable influence on the leakage flow, that is to say which use energy contained in the leakage flow or which compress, expand, heat or cool the leakage flow. Since the unit is directly connected to the compressor, the arrangement according to the invention is cost-effective to produce.

One particularly preferred variant of the invention provides that the unit can be driven by energy contained in the leakage flow. The unit is thus driven directly by the kinetic and/or potential energy contained in the leakage flow. Since no conversion or conditioning of the leakage flow is required, operation of the arrangement according to the invention can be particularly energy-efficient.

Preferred embodiments of the invention provide that the arrangement has at least one component selected from the following group, which can be charged by the unit with an air stream for temperature control and/or ventilation: fuel cell, fuel cell arrangement, reformer, methanol reformer.

It is also within the scope of the invention that the arrangement is designed as a static arrangement for supplying energy, or alternatively as an airborne vehicle, a land vehicle or a water vehicle. The various embodiments described can of course be combined with one another in various variants. It is for example possible for an arrangement to have multiple turbomachines, or for one turbomachine to have multiple bleed air lines connected to different units, in particular to pumps, jet pumps or fans.

The invention also relates to an operating method for an arrangement, comprising a turbomachine with a compressor, a combustion chamber and a turbine, and with a bleed air line, through which a leakage flow flows or can flow and which is connected via a controllable valve to the compressor, wherein the leakage flow can be or is supplied by the bleed air line to a unit.

The operating method according to the invention is characterized in that a fan, jet pump or pump which can be or is driven by the leakage flow is used as the unit.

### BRIEF DESCRIPTION OF THE DRAWINGS

There follows a more detailed explanation of the invention, by means of exemplary embodiments and with reference to the drawings. The drawings are schematic illustrations, in which:

FIG. 1 shows a first exemplary embodiment of an arrangement according to the invention; and

FIG. 2 shows a second exemplary embodiment of an arrangement according to the invention.

### DETAILED DESCRIPTION OF THE INVENTION

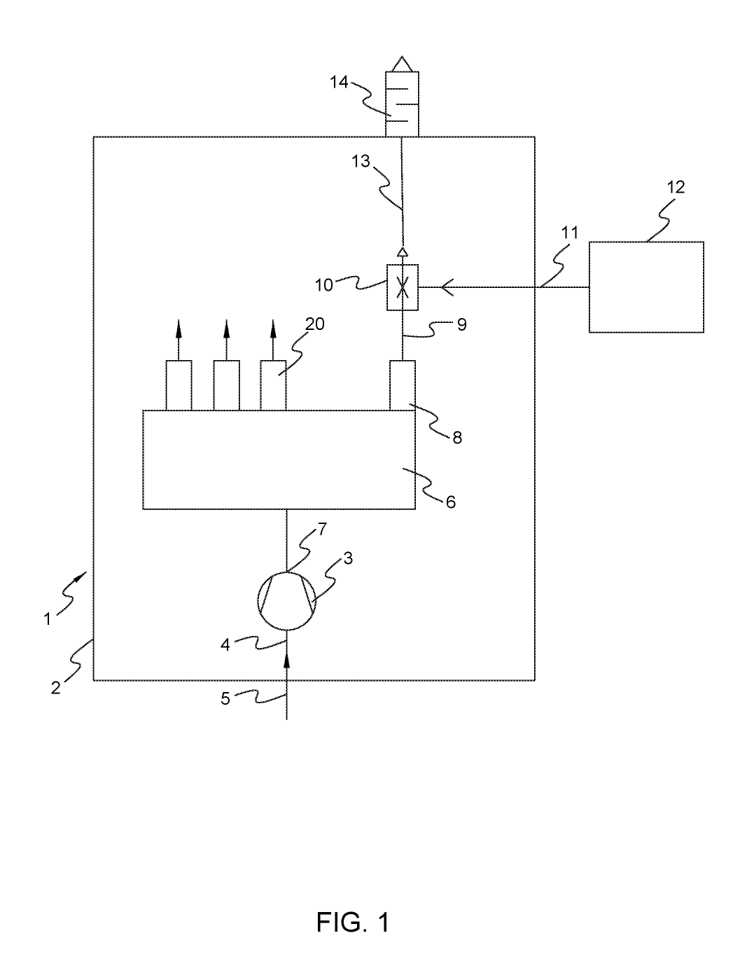

The arrangement 1 illustrated schematically in FIG. 1 comprises a turbomachine 2, in the form of a turbocompressor, with a compressor 3 that has an inlet 4 for an aspirated gas such as air. The inflowing gas is illustrated schematically in FIG. 1 by an arrow 5. The compressor 3 has an outlet 7 connected to a plenum 6. The plenum 6 serves to distribute the mass flow generated by the compressor 3. To that end, there are multiple outlets 20 that are connected to other sub-assemblies (not shown). In order to operate the turbomachine 2 at a certain operating point within a fixed characteristic diagram, the plenum 6 has a controllable valve 8. The controllable valve 8 serves to set a certain pressure in the plenum 6, by the controllable valve 8 being partially or fully open. Connected to the controllable valve 8 is a bleed air line 9, via which the plenum 6 is connected to a unit that, in this exemplary embodiment, is designed as a jet pump 10. The jet pump 10 is thus driven by a leakage flow (leakage mass flow) which, in conventional arrangements, escapes unused. In contrast, the arrangement 1 shown in FIG. 1 makes it possible to use the energy, in particular the kinetic energy and the potential energy, contained in the leakage flow to drive the jet pump 10. When the jet pump 10 is driven, it generates a mass flow. It can for example be used as a vacuum pump. Alternatively, it can be used for controlled ventilation and/or temperature control of a sub-assembly. In this exemplary embodiment, the jet pump 10 is connected via a vacuum line 11 to a fuel cell arrangement 12. Thus, the vacuum generated by the jet pump 10 permits targeted ventilation of the fuel cell arrangement 12.

After flowing through the jet pump 10, the leakage flow arrives, via a line 13, at an outlet 14 of the arrangement 1. In this exemplary embodiment, the arrangement 1, which encompasses the turbomachine 2 and the fuel cell arrangement 12, is part of an aircraft.

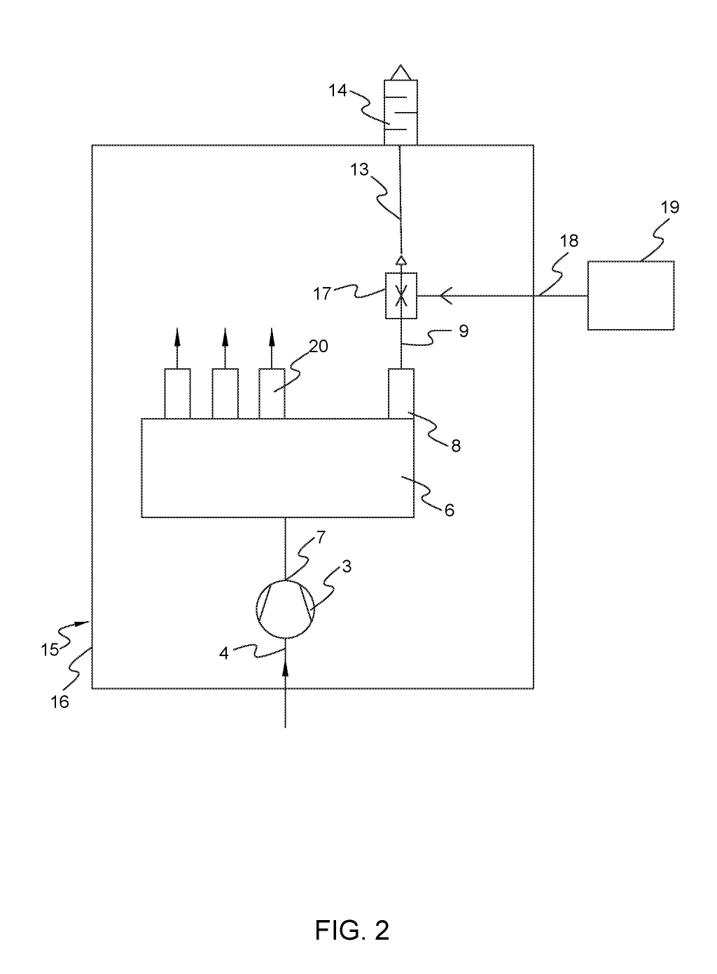

FIG. 2 shows another exemplary embodiment of an arrangement 15, which largely corresponds with the arrangement 1 shown in FIG. 1. Therefore, the same reference signs are used for corresponding components. In accordance with the first exemplary embodiment, the arrangement 15 comprises a turbomachine 16 with the compressor 3 that has the inlet 4 and the outlet 7. Adjoining this is the plenum 6 which has a small volume in relation to the mass flow of the turbomachine 16. The controllable valve 8 is connected to the plenum 6 and, via the bleed air line 9, to a unit designed as a fan 17. The fan 17 is driven by the leakage flow that is diverted from the compressor 3. The fan 17 is connected via a line 18 to a reformer 19 of a fuel cell arrangement (not shown). The reformer 19 is actively ventilated by the fan 17. It is also possible for a directed coolant flow to be generated. Furthermore, the reformer 19 can be subjected to a slight vacuum with respect to the surroundings.

The arrangements 1, 15 shown in FIGS. 1 and 2 make it possible to use energy contained in the leakage flow of the compressor 3 in order to drive a unit, which can for example be designed as a jet pump 10 or as a fan 17. Thus, a substantial part of the energy contained in the leakage flow, which in the case of conventional applications is discharged to the environment either partially or completely unused, is converted into kinetic energy, and as a consequence the turbomachine 2, 16 can be operated more efficiently in terms of its energy consumption. It is therefore possible for the fan 17 and the jet pump 10 driven by the leakage flow to replace other drives, or for such other drives to be made smaller and more lightweight, thus resulting in advantages in terms of weight and/or cost.

### LIST OF REFERENCE SIGNS

1 Arrangement

2 Turbomachine

3 Compressor

4 Inlet

5 Arrow

6 Plenum

7 Outlet

8 Controllable valve

9 Bleed air line

10 Jet pump

11 Vacuum line

12 Fuel cell arrangement

13 Line

14 Outlet

15 Arrangement

16 Turbomachine

17 Fan

18 Line

19 Reformer

20 Outlet

What is claimed is:

1. An arrangement comprising a turbomachine with a compressor having an outlet, and with a bleed air line, through which a leakage flow can flow and which is connected via a controllable valve to the outlet of the compressor, for supplying the leakage flow to a unit, wherein the unit is designed as a fan, jet pump or pump which can be driven by the leakage flow.

2. The arrangement according to claim 1, wherein the outlet of the compressor is connected to the controllable valve via a plenum.

3. The arrangement according to claim 1, wherein neither a pre-cooler nor a compressor is arranged between the controllable valve and the unit.

4. The arrangement according to claim 1, wherein the unit can be driven by energy contained in the leakage flow.

5. The arrangement according to claim 1, wherein it has at least one component which can be charged by the unit with an air stream for temperature control and/or ventilation, said at least one component being selected from the group consisting of a fuel cell, a fuel cell arrangement, a reformer and a methanol reformer.

6. The arrangement according to claim 1, wherein it is designed as a static arrangement for supplying energy, or as an airborne vehicle, a land vehicle or a water vehicle.

7. An operating method for an arrangement comprising a turbomachine with a compressor having an outlet, a combustion chamber and a turbine, and with a bleed air line through which a leakage flow flows or can flow and which is connected via a controllable valve to the outlet of the compressor, wherein the leakage flow can be or is supplied by the bleed air line to a unit, wherein a fan, jet pump or pump which can be or is driven by the leakage flow is used as the unit.

8. The operating method according to claim 7, wherein the outlet of the compressor is connected to the controllable valve via a plenum, and the leakage flow is drawn from the plenum by means of the controllable valve.

9. The operating method according to claim 7, wherein the unit is driven by the energy contained in the leakage flow.

10. The operating method according to claim 7, wherein use is made of at least one component which is or can be charged by the unit with an air stream for temperature control and/or ventilation, said at least one component being selected from the group consisting of a fuel cell, a fuel cell arrangement, a reformer and a methanol reformer.
